(19) United States
(12) Patent Application Publication
(10) Pub. No.: US 2025/0006384 A1
(43) Pub. Date: Jan. 2, 2025

(54) A REACTOR CONTROL SYSTEM

(71) Applicant: BAE SYSTEMS PLC, London (GB)

(72) Inventor: Jeremy Henry Owston, Barrow-in-Furness Cumbria (GB)

(73) Assignee: BAE SYSTEMS PLC, London (GB)

(21) Appl. No.: 18/710,372

(22) PCT Filed: Nov. 9, 2022
(86) PCT No.: PCT/GB2022/052831

§ 371 Date: May 15, 2024

(30) Foreign Application Priority Data
Nov. 15, 2021 (GB) 2116436.3

(51) Int. Cl. G21C 7/14; G21C 7/10

(52) U.S. Cl. CPC G21C 7/14; G21C 7/10

(57) ABSTRACT

A reactor control system (100) for a nuclear fission reactor system comprising a nuclear reactor unit (300) having a reactor core (302) with a central axis (320) extending along the length of the reactor core (302). The nuclear reactor unit (300) comprises a first region (310) provided in the reactor core (302) and a second region (312) provided outside of the reactor core (302). The control system (100) comprises a control duct (200) having a first portion (210) configured to extend through the first region (310) and a second portion (220) configured to extend through the second region (312). The duct (200) is filled with a series of control units (400), each of the control units (400) configured to travel along the control duct (200).

### FIELD

The present disclosure relates to a reactor control system.

In particular the disclosure is concerned with a reactor control system for a nuclear fission reactor system comprising a nuclear reactor unit.

### BACKGROUND

One aspect of all graphite moderated nuclear fission reactor units, due to the low moderating power of graphite, is their nuclear core size is proportionally significantly larger relative to a water moderated reactor for given power capability. Hence the reactor unit and associated components, unlike water cooled reactors, typically dominate in the overall sizing of the power generation package.

By way of illustration, an example of a graphite moderated nuclear fission reactor 1 (General Atomics GT-MHR) is shown in FIG. 1. Common to many designs, this arrangement has traditional straight control rods 2 which must be placed above the reactor vessel 3. As is well known, the control rods must extend into and out of the reactor. Hence a space equivalent to the core height must be available to allow the control rods to be fully removed from the reactor.

Removal of the control rod support structure 4 will reduce the size and weight of the reactor unit 1. Additionally, reducing reactor unit size will overall reduce the volume of space needed to house it, and consequently will reduce the amount, and hence weight, of material needed to house the power unit. This is important as, in some applications, space and weight are at a premium. For example, reducing the reactor unit size in a nuclear powered water vessel (and in particular submersibles, e.g. submarines) makes space for other equipment, or contributes to a goal of making the vessel smaller and lighter.

Hence configurations which enable a more compact reactor unit design for the same power output and level of control is highly desirable.

### SUMMARY

According to the present disclosure there is provided an apparatus and system/method as set forth in the appended claims. Other features of the invention will be apparent from the dependent claims, and the description which follows.

Hence there may be provided a reactor control system (100) for a nuclear fission reactor system comprising a nuclear reactor unit (300) having a reactor core (302) with a central axis (320) extending along the length of the reactor core (302). The nuclear reactor unit (300) may comprise a first region (310) provided in the reactor core (302) and a second region (312) provided outside of the reactor core (302). The control system (100) may comprise a control duct (200) having a first portion (210) configured to extend through the first region (310) and a second portion (220) configured to extend through the second region (312). The duct (200) may be filled with a series of control units (400), each of the control units (400) configured to travel along the control duct (200).

The control duct (200) may be configured for the translation of the control units (400) in a first direction D1 and in a second direction D2. The first direction D1 may be in a direction of travel from the second portion (220) towards the first portion (210). The second direction D2 may be in a direction of travel from the first portion (210) towards the second portion (220).

The control duct (200) may comprise a first arcuate portion (230) which extends between the first portion (210) and the second portion (220), the control duct (200) first portion (210), first arcuate portion (230) and second portion (220) thereby defining a continuous path for the passage of control units (400).

The control duct (200) may comprise: a second arcuate portion (240) which extends between the first portion (210) and the second portion (220), the second arcuate portion (240) provided at the opposite end of the first portion (210) and second portion (220) to the first arcuate portion (230), such that the first arcuate portion (230) is spaced apart from the second arcuate portion (240) by the first portion (210) and the second portion (220). The control duct (200) first portion (210), first arcuate portion (230), second portion (220) and second arcuate portion (230) may thereby define a single continuous loop path for the passage of control units (400).

The control system may further comprise a first tank (700) for storage of control units (400). The control duct (200) may be configured to receive and/or supply control units (400) from/to the first tank (700). The control system may further comprise a second tank (720) for storage of control units (400). The control duct (200) may be configured to receive and/or supply control units (400) from/to the second tank (720). The first tank (700), first portion (710), first arcuate portion (230), second portion (220) and second tank (720) may be provided in series to define a path for the passage of control units (400).

Some of the control units (400) may be absorber units (410). Some of the control units may be displacer units (420).

The absorber units (410) may be less heavy than the displacer units (420).

The control units (400) may be spherical and have an external diameter which is the same as, or slightly smaller than the diameter of the control duct (200).

The control system may further comprise a drive mechanism (600) which in a first mode of operation is operable to drive the control units (400) in the first direction D1 around the control duct (200) and in a second mode of operation is operable to drive the control units (400) in the second direction D2 around the control duct (200).

The drive mechanism (600) may comprise a screw (602) with a track (604) for engagement with the control units (400), such that when the screw (602) rotates, the control units (400) are driven along the duct (200).

The screw (602) may be configured to move between a first position in which it is operable to drive the control units (400) and a second position in which a clearance is maintained between the screw (602) and the control units (400).

The reactor control system (100) may further comprise a non-return mechanism (1100) provided in the control duct (200), configured to have a first mode of operation in which the control units (400) are able to move relative to the control duct (200) and a second mode of operation in which the control units (400) are fixed in position relative to the control duct (200).

The control duct (200) may have a substantially constant diameter along its length.

At least part of the second portion (220) of the control duct (200) may have a diameter which is greater than the diameter of the first portion (210) of the control duct (200). The second portion (220) may be in fluid communication with a pressure source (1000) such that when the screw (602) is in the second position the control units (400) are forced in the first direction D1 by the pressure source.

A plurality of absorber units (410) may be provided in series and adjacent one another along the control duct (200) to form a line (416) of absorber units (410). A first plurality of displacer units (420) may be provided in series and adjacent one another along the control duct (200) to form a first line (422) of displacer units (420). A second plurality of displacer units (420) may be provided in series and adjacent one another along the control duct (200) to form a second line (424) of displacer units (420). The first line (422) of displacer units (420) may extend from a first end (412) of the line of absorber units (410). The second line (424) of displacer units (420) may extend from a second end (414) of the line of absorber units (410).

A piston (500) may be provided between the first line (422) of displacer units (420) and the second line (424) of displacer units (420), such that in the first direction D1 the plurality of absorber units (410) is spaced apart from the piston (500) by the first line (422) of displacer units (420) and in the second direction D2 the plurality of absorber units (410) is spaced apart from the piston (500) by the second line (424) of displacer units (420).

The piston (500) may be configured and located in the duct (200) such that when the screw (602) is in the second position, the piston (500) acts on the control units (400) beneath it to move them around the duct (200).

The first portion (210) of the control duct (200) may extend substantially parallel to the core central axis (320). The second portion (220) of the control duct (200) may extend substantially parallel to the core central axis (320).

There may be provided a nuclear fission reactor system comprising: a nuclear reactor unit (300), and a reactor control system (100) according to the present disclosure.

Hence there is provided a control system for a nuclear fission reactor which is more compact than prior designs and overall significantly reduces the size of the reactor unit to which it is included.

### BRIEF DESCRIPTION OF THE FIGURES

Examples of the present disclosure will now be described by way of example only with reference to the figures, in which:

FIG. 1 shows a conventional moderated nuclear fission reactor of the related art;

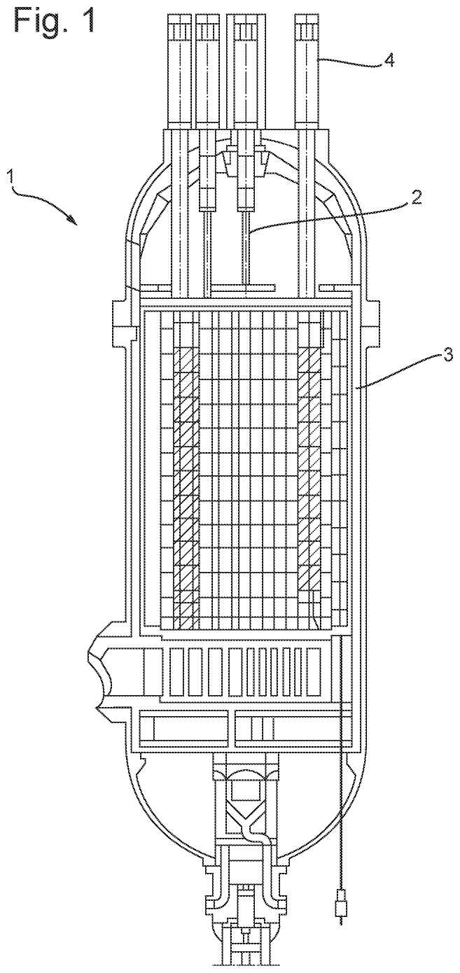

FIG. 2 is a representation of a nuclear reactor unit with part of its shell removed, with a reactor control system according to the present disclosure;

FIG. 3 is a cross-sectional view of the nuclear reactor unit and reactor control system as shown in FIG. 2 in an operational configuration;

FIG. 4 is a cross-sectional view of the nuclear reactor unit and reactor control system as shown in FIG. 2 in a shut down configuration;

FIG. 5 is a cross-sectional view of an alternative example of a nuclear reactor unit and reactor control system according to the present disclosure in an operational configuration;

FIG. 6 is a cross-sectional view of the nuclear reactor unit and reactor control system as shown in FIG. 5 in a shut down configuration;

FIG. 7 is an enlarged view of part of an example of the reactor control system according to the present disclosure in a shut down configuration;

FIGS. 8,9 are enlarged views of part of an example of the reactor control system according to the present disclosure; and

FIG. 10 shows an enlarged view of part of a further example of the reactor control system according to the present disclosure.

### DETAILED DESCRIPTION

The present disclosure relates to a reactor control system 100 for a nuclear fission reactor system. The present disclosure also relates to a nuclear fission reactor system comprising a nuclear reactor unit 300, and a reactor control system 100 according to the present disclosure.

For example, the reactor control system of the present disclosure may be used to control a high temperature gas cooled reactor (HTGR). The system may be a direct cycle design where the reactor core directly heats a working fluid driving a turbine to generate power. The coolant may, for example, be nitrogen. Features of such systems are well known in the art and hence the details are not herein described.

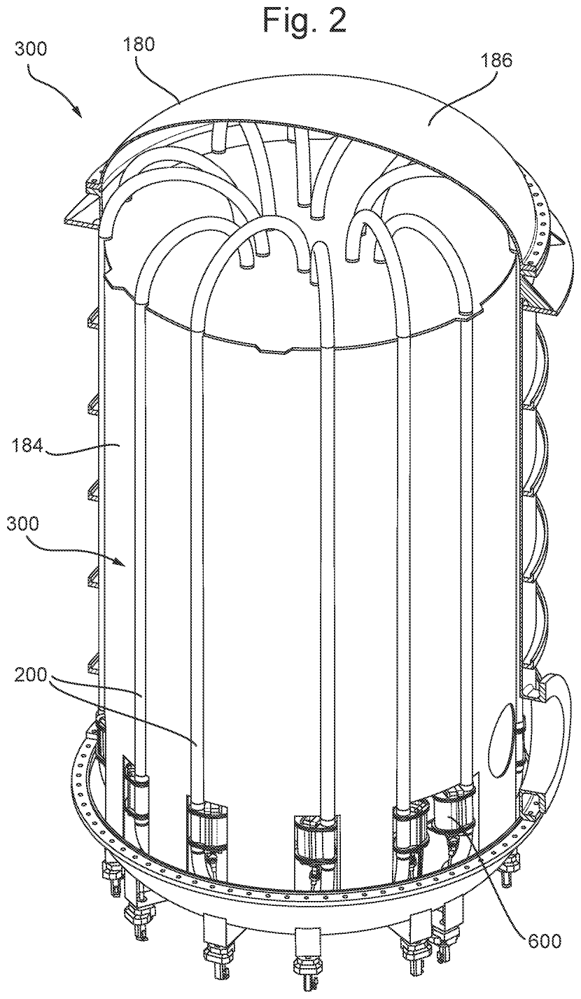

Hence the reactor control system 100 of the present disclosure may form part of a nuclear fission reactor system. As shown in FIGS. 2 to 6, the nuclear fission reactor system may comprise a nuclear reactor unit 300 having a reactor core 302 with a central axis 320 extending along the length of the reactor core 302 from a first end to a second end of the reactor core 302. The figures of the present disclosure relate only to the nuclear reactor unit 300, the other features of the nuclear fission reactor system (for example heat exchangers, turbines etc) are not shown.

As shown in FIGS. 2 to 6, the reactor core 302 may be surrounded by a shield 184 (or “core barrel”), a casing shell 180 (which defines a “reactor pressure vessel”) which houses the core 302 and shield 184, the casing 180 spaced apart from the shield 184 to define a cooling annulus 182, the shell 180 defining an outer surface 186.

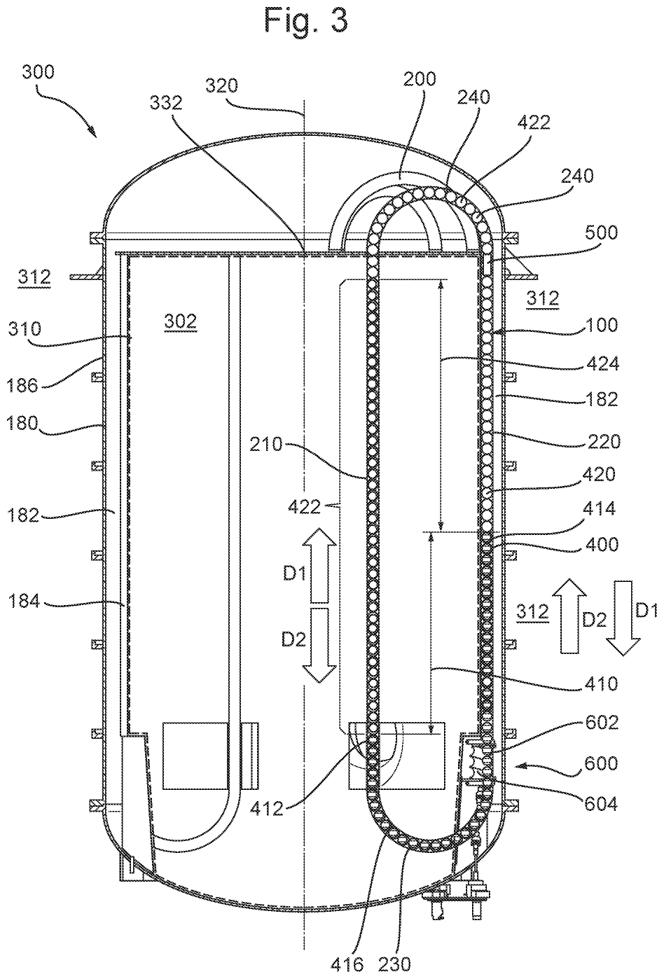

As illustrated in FIGS. 3 to 6, the nuclear reactor unit 300 comprises a first region 310 provided in the reactor core 302 and a second region 312 provided outside of the reactor core 302. Hence the second region 312 is located outward of the outer perimeter of the reactor core 302. That is, the first region 310 is provided in the reactor core 302 inside of shield 184 of the reactor core, and the second region 312 is outside of the shield 184 of the reactor core 302. The second region 312 may be adjacent to the shield 184 of the reactor core 302. The second region 312 may be adjacent to the outer surface 186 of the shell 180. The second region 312 may be adjacent to the shell 180. The first region 310 is located between the central axis 320 and the second region 312, the second region 312 being outside of the first region 310. The second region 312 may include the cooling annulus 182. For example, the first region 310 is the region within (i.e. enclosed by) the dashed line labelled “310” in FIGS. 3 to 6, defined by the shield 184, and the second region 312 surrounds (i.e. is outside of) the first region 310 (i.e. outside of the region enclosed by the dashed line labelled “310”). That is to say, the second region 312 is outside of the volume defined by the shield 184 and defines a volume which bounds the first region 310.

The control system 100 comprises a control duct 200. As shown in FIG. 2, the control system 100 may comprise a plurality of control ducts 200 spaced apart around the core central axis 320. The or each control duct may be provided as a passage, pipe or tube, and may be circular in cross-section, for example forming a cylindrical passage. The or each control duct 200 may comprise a first portion 210 configured to extend through the first region 310, and a second portion 220 configured to extend through the second region 312.

The control duct second portion 220 may extend through the cooling annulus 182. The second portion 220 of the control duct 200 may be housed within the cooling annulus 182. That is to say, the second portion 220 of the control duct 200 may be located entirely within the cooling annulus 182.

The first portion 210 of the control duct 200 may extend substantially parallel to the core central axis 320. The second portion 220 of the control duct 200 may extend substantially parallel to the core central axis 320. Hence the second portion 220 of the control duct 200 may extend substantially parallel to the first portion 210 of the control duct 200.

In alternative examples, not shown, the first portion 210 of the control duct 200 may extend at an angle to the core central axis 320, and/or the second portion 220 of the control duct 200 may extend at an angle to the core central axis 320. Hence the second portion 220 of the control duct 200 may extend at an angle to and/or parallel to the first portion 210 of the control duct 200.

The duct 200 is filled with a series of control units 400, each of the control units 400 configured to travel along the control duct 200.

The control duct 200 is configured for the translation of the control units 400. That is to say, the control duct 200 is configured to allow the control units 400 to travel along the control duct 200. The control duct 200 is configured for the translation of the control units 400 in a first direction D1 and in a second direction D2. The first direction D1 is a direction of travel from the control duct second portion 220 towards the control duct first portion 210. The second direction D2 is a direction of travel from the control duct first portion 210 towards the control duct second portion 220.

The control duct 200 may comprise a first arcuate portion 230 which extends between the control duct first portion 210 and the control duct second portion 220 such that the first portion 210, first arcuate portion 230 and second portion 220 of the control duct 200 define a continuous path for the passage of control units 400.

The first arcuate portion 230 of the control duct 200 may be semi-circular.

That is to say, the first arcuate portion 230 may be configured so that that it defines a path for control units 400 which turns 180 degrees from where it extends from one of the control duct first portion 210 or the control duct second portion 220 to the other of the control duct first portion 210 or the control duct second portion 220.

As shown in the examples of FIGS. 2 to 4, the control duct 200 may comprise a second arcuate portion 240 which extends between the first portion 210 and the second portion 220 of the control duct 200. In this example, the second arcuate portion 240 of the control duct 200 is provided at the opposite end of the first portion 210 and second portion 220 to the first arcuate portion 230, such that the first arcuate portion 230 is spaced apart from the second arcuate portion 240 by the first portion 210 and the second portion 220.

The second arcuate portion 240 of the control duct 200 may be semi-circular. That is to say, the second arcuate portion 240 of the control duct 200 may be configured so that that it defines a path for control units 400 which turns 180 degrees from where it extends from one of the first portion 210 or the second portion 220 to the other of the first portion 210 or the second portion 220 of the control duct 200.

Hence, as shown in the examples of FIG. 2 to 4, the first portion 210, first arcuate portion 230, second portion 220 and second arcuate portion 230 of the control duct 200 define a single continuous loop path for the passage of control units 400.

The first portion 210, first arcuate portion 230, second portion 220 and second arcuate portion 240 of the control duct 200 may thus be provided in series to define a single continuous loop path for the passage of control units 400.

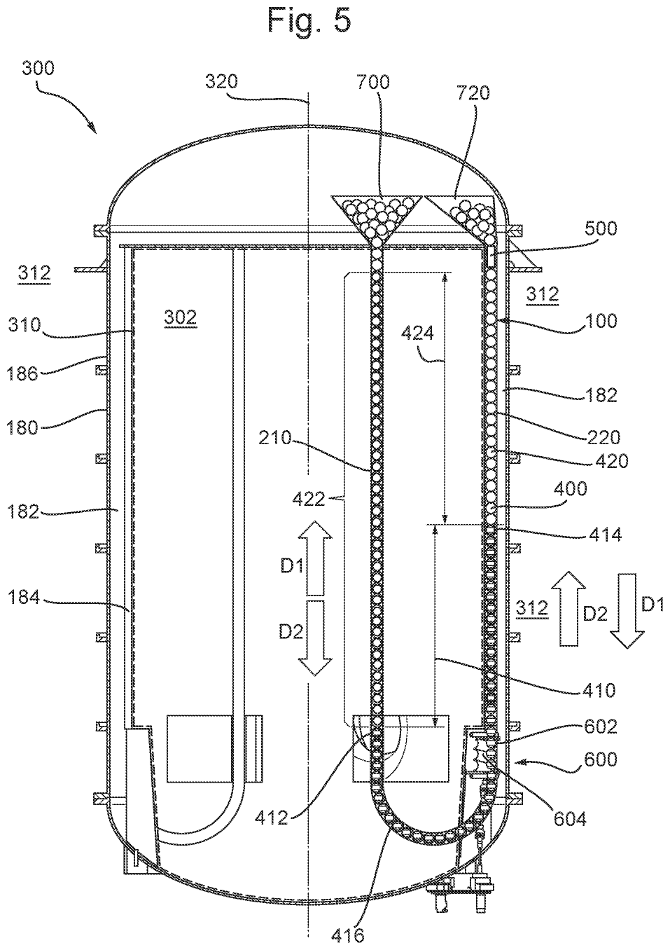

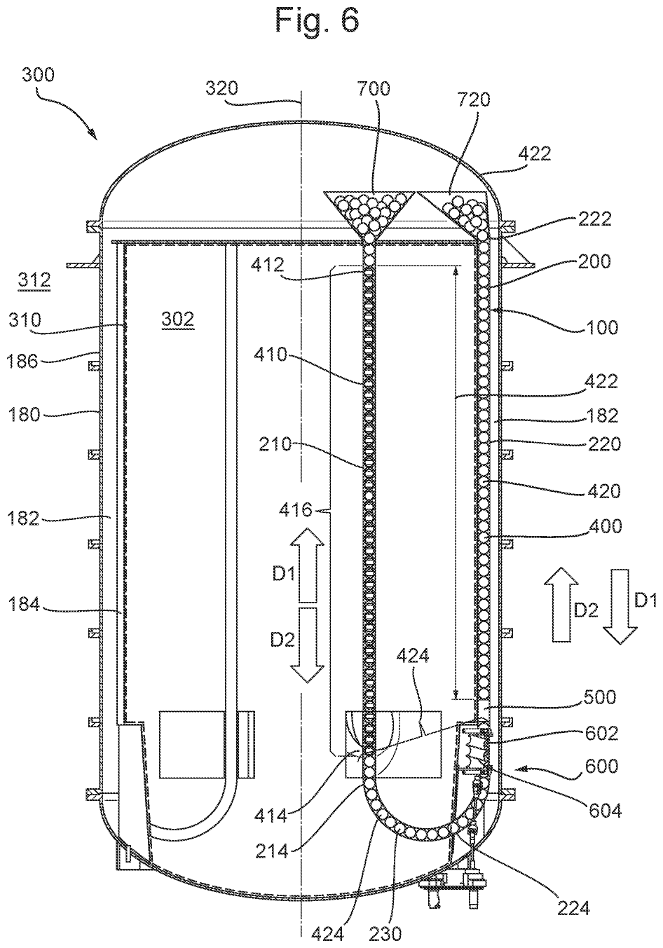

In an alternative example shown in FIGS. 5, 6, instead of the second arcuate portion 240 of the examples of FIGS. 2 to 4, there may be provided a first tank 700 for storage of control units 400, wherein the control duct 200 is configured to receive and/or supply control units 400 from/to the first tank 700, and a second tank 720 for storage of control units 400, the control duct 200 configured to receive and/or supply control units 400 from/to the second tank 720.

Hence in the example of FIGS. 5, 6, the first tank 700, first portion 710, first arcuate portion 230, second portion 220 and second tank 720 of the control duct 200 are provided in series to define a path for the passage of control units 400 between the first tank 700 and second tank 720.

The reactor core 302, and its central axis 320, may extend vertically (as illustrated in the figures). Hence, in the examples of FIGS. 2 to 4, if the nuclear reactor unit 300 is mounted on a horizontal substrate, for example a floor in a building, the reactor core 302, and its central axis 320 extend so the second arcuate portion 240 is vertically above the first arcuate portion 230.

Alternatively, in the examples of FIGS. 5, 6 if the nuclear reactor unit 300 is mounted on a horizontal substrate, for example a floor in a building, the reactor core 302, and its central axis 320 extend so the first tank 700 and second tank 720 are vertically above the first arcuate portion 230.

In further examples having a similar configuration to the examples of FIG. 2 to 4, the reactor may be mounted horizontally. In such examples, if the nuclear reactor unit 300 is mounted on a horizontal substrate, for example a floor in a building, the reactor core 302, and its central axis 320 extends horizontally so the second arcuate portion 240 is at the same height above the substrate to the first arcuate portion 230.

Some of the control units 400 are absorber units 410. At least some of the remainder of the control units 400 are displacer units 420.

The absorber units 410 may be configured to absorb radiation energy. For example, the absorber units 410 may be configured to absorb particles that contribute to making a nuclear chain reaction work. For example, the absorber units 410 may be configured to absorb neutrons. The absorber units 410 may comprise boron carbide particles. The displacer units 420 are configured to have lower absorption properties than the absorber units 410. The displacer units 420 may comprise graphite.

In the examples shown, a plurality of absorber units 410 are provided in series and adjacent one another (that is, in a line) along the control duct 200 to form a line 416 of absorber units 410. A first plurality of displacer units 420 are provided in series and adjacent one another (that is, in a line) along the control duct 200 to form a first line 422 of displacer units 420. A second plurality of displacer units 420 are provided in series and adjacent one another along the control duct 200 to form a second line 424 of displacer units 420. The first line 422 of displacer units 420 extends from a first end 412 of the line of absorber units 410 in the first direction D1 along the duct 200, and the second line 424 of displacer units 420 extends from a second end 414 of the line of absorber units 410 in the second direction D2 around the duct 200.

The absorber units 410 may be less heavy than the displacer units 420. The absorber units 410 may be at least 2% lighter than the displacer units 420 but not more than 80% lighter than the displacer units. The absorber units 410 may be at least 10% lighter than the displacer units 420 but not more than 50% lighter than the displacer units. The absorber units 410 may be at least 20% lighter than the displacer units 420 but not more than 30% lighter than the displacer units.

The control units 400 may be spherical. The control units 400 may have an external diameter which is the same as, or slightly smaller than the diameter of the control duct 200.

The control units 400 may have a diameter of at least 10 mm, and no more than 300 mm. The control units 400 may have a diameter of at least 50 mm, and no more than 150 mm. The control units 400 may have a diameter of at least 90 mm, and no more than 110 mm. The control units 400 may have a diameter of about 100 mm.

As shown in the examples of FIG. 2 to 7, there may be further provided a drive mechanism 600 which in a first mode of operation is operable to drive the control units 400 in the first direction D1 around the control duct 200 and in a second mode of operation is operable to drive the control units 400 in the second direction D2 around the control duct 200.

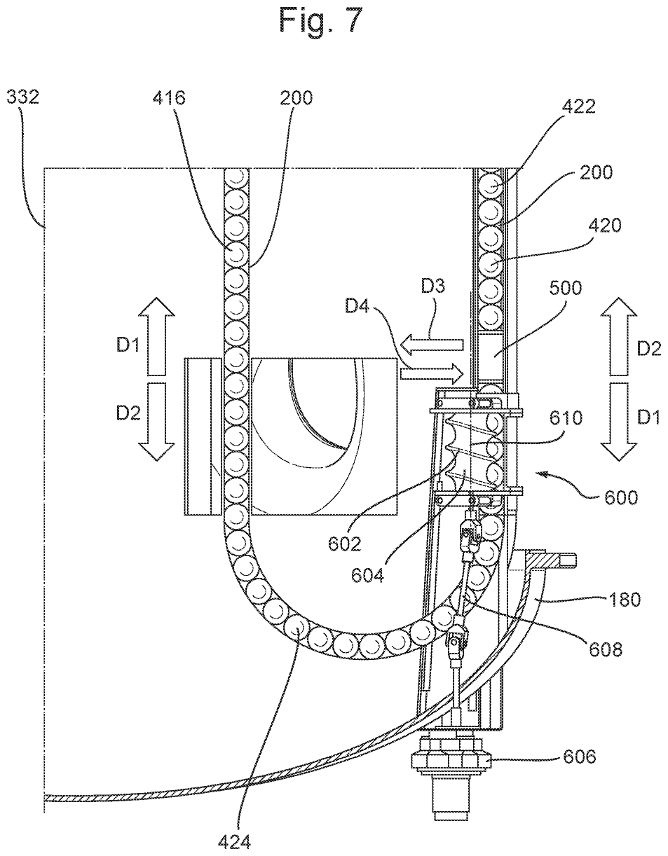

As best shown in FIG. 7, the drive mechanism 600 may comprise a screw 602 with a track 604 for engagement with the control units 400, such that when the screw 602 rotates, the control units 400 are driven along the duct 200. The track 604 may be provided as a screw thread to form an Archimedes screw type arrangement. The screw 602 is rotatable about an axis 610, and may be drivable by a drive motor 606. A drive arm 608 may extend from the drive motor 606 to the screw 602. Hence the drive motor 606 may be operable to turn the screw 602 about the rotational axis 610 to thereby move the control units 400 along the duct 200.

As illustrated in FIG. 7, the screw 602 is configured to move between a first position (as shown in FIG. 7) in which it is operable to drive the control units 400 and a second position in which a clearance is maintained between the screw 602 and the control units 400 (not shown). That is to say, in the second position the screw 602 is spaced apart from the control units 400. The screw 602 may be configured to move in a first displacement direction (as indicated by arrow D3 in FIG. 7) between the first position (as shown in FIG. 7) in which the screw 602 is operable to drive the control units 400, to the second position in which a clearance is maintained between the screw 602 and the control units 400 such that the control units 400 are not engaged with the screw 602 as they pass by the screw 602. The screw 602 may be configured to move in a second displacement direction (as indicated by arrow D4 in FIG. 7) between the second position in which the screw 602 is spaced apart from the control units 400 to the first position (as shown in FIG. 7) in which the screw 602 is operable to drive the control units 400.

A piston 500 is provided between the first line 422 of displacer units 420 and the second line 424 of displacer units 420, such that in the first direction D1 the plurality (i.e. line of) of absorber units 410 are spaced apart from the piston 500 by the first line 422 of displacer units 420 and in the second direction D2 the plurality (i.e. line of) of absorber units 410 is spaced apart from the piston 500 by the second line 424 of displacer units 420.

The piston 500 is configured and located in the duct 200 such that when the screw 602 is in the second position (in which a clearance is maintained between the screw 602 and the control units 400), the piston 500 acts on the control units 400 beneath it to move them around the duct 200. Hence the piston 500 may have a mass which by itself and/or when combined with the weight of at least some of the first line 422 of displacer units 420 (e.g. when the reactor is mounted vertically as shown in the figures) forces the second line 424 of displacer units 420 to travel along the duct 200 the first direction D1 so that the absorber units 410 are located in (i.e. moved to) the first region 310 of the reactor core 302.

The screw 602 may mounted biased towards the second position in which the screw 602 is spaced apart from the control units 400, for example by a spring. The screw 602 may be maintained in the first position in which the screw 602 is operable to drive the control units 400 by an actuator and/or pressure from a pressure source. In the event of a failure of the system, the actuator and/or pressure source release the screw 602 so it assumes the second position, thereby allowing the control units 400 to move along the duct 200.

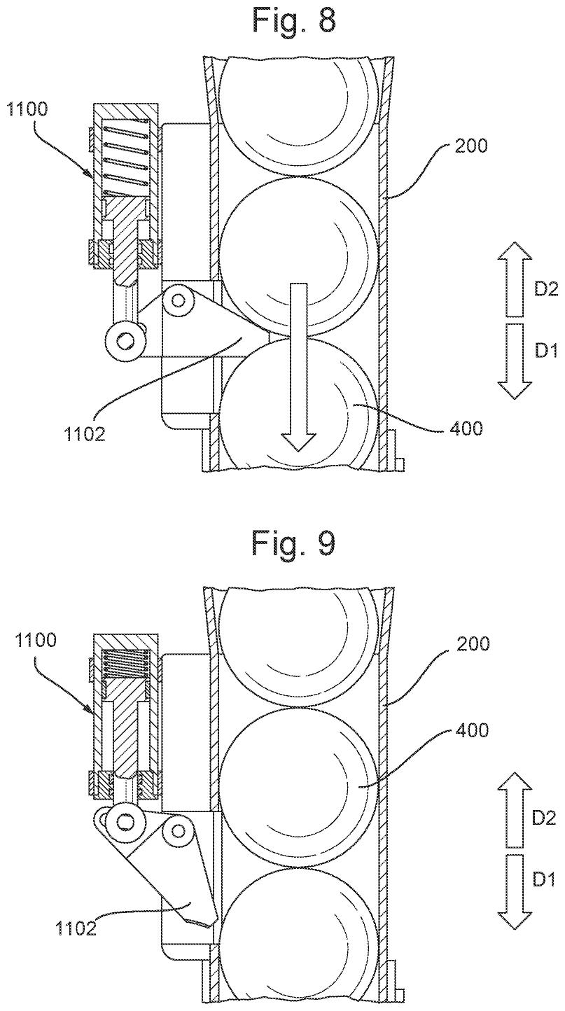

As shown in FIGS. 8, 9, the reactor control system 100 may further comprise a non-return mechanism 1100 provided in the control duct 200, configured to have a first mode of operation in which the control units 400 are able to move relative to the control duct 200 and a second mode of operation in which the control units 400 are fixed in position relative to the control duct 200.

The non-return mechanism 1100 may be provided in the second portion 220. The non-return mechanism 1100 may be provided in the first portion 210.

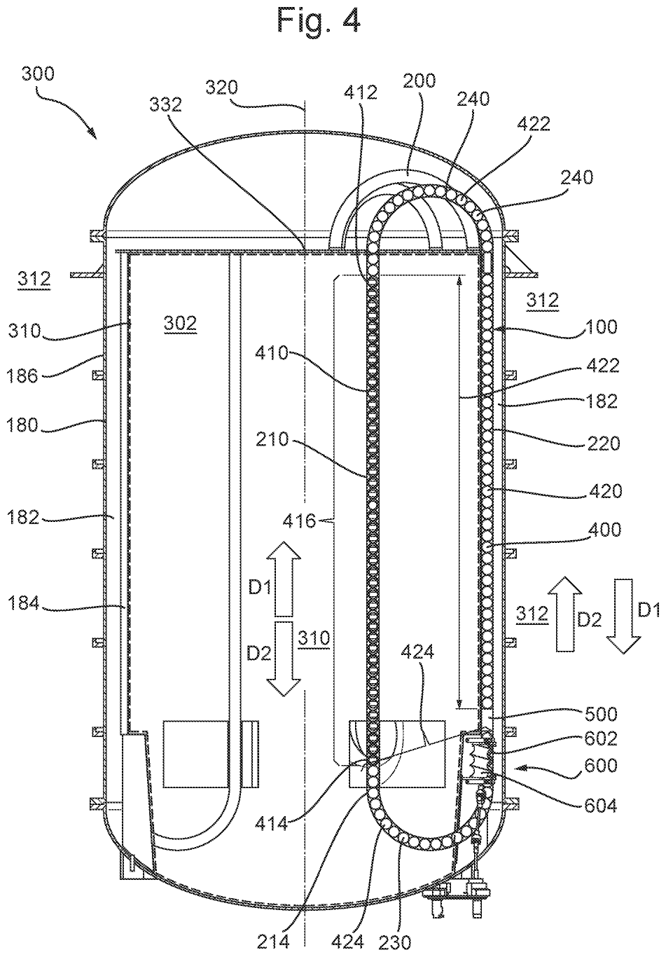

As shown in FIGS. 8, 9 the non-return mechanism 1100 may comprise a ratchet component 1102. In a first configuration (i.e. an operational configuration as shown in FIG. 3, 5, 9) control units 400 are able to push/move past the ratchet component 1102 in the first direction D1 and/or second direction D2. In a second configuration (i.e. a shut down configuration as shown in FIG. 4, 6, 8) the ratchet component 1102 allows the passage of control units 400 past the ratchet component 1102 in the first direction D1 but does not allow the passage of control units 400 past ratchet component 1102 in the second direction D2.

Hence in normal operation (i.e. an operational configuration), the non-return mechanism 1100 is in its first configuration. However, if shutdown is required the non-return mechanism 1100 is translated to its second configuration to allow the absorber units 410 to move in the first direction D1 into the core (i.e. into, or in a direction towards, the first region 310) but to prevent them from moving in the second direction D2 (i.e. into, or in a direction towards, the second region 320).

As shown in FIGS. 3 to 6, the control duct 200 may have a substantially constant diameter.

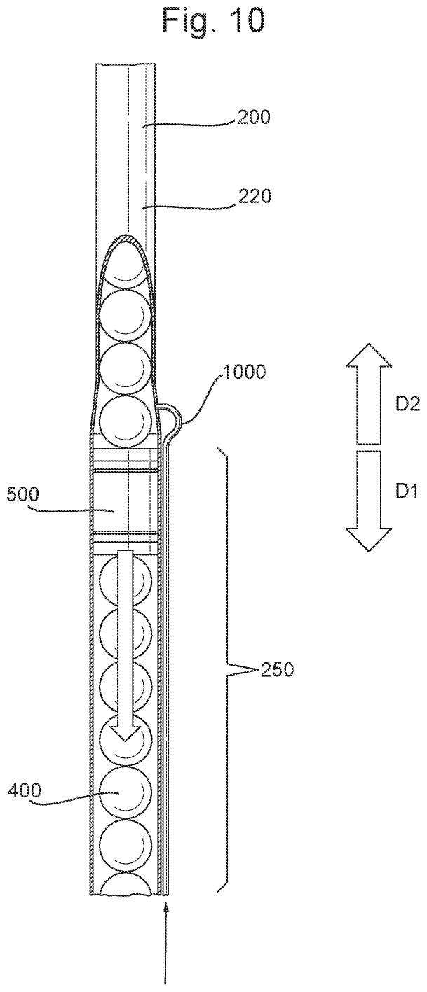

In an alternative example, for example as shown in FIG. 10, at least part of the second portion 220 of the control duct 200 has a diameter which is greater than the diameter of the first portion 210 of the control duct 200. This region of enlarged diameter may be located such the first portion 210, region of enlarged diameter and drive mechanism 600 are provided in series in the second direction D2.

In this example the second portion 220 is in fluid communication with a pressure source 1000 such that when the screw 602 is in the second position the control units 400 are forced in the first direction D1 by the pressure source.

Hence in this example, the piston 500 and control duct 200 are enlarged such that there is a differential area between the control unit 400 diameter and the piston 500. Hence the diameter of the enlarged region 250 may be 5% to 10% greater than the diameter of the control units 400. The control units 400 on entering enlarged region 250 of the control duct 200 act as a valve, thereby limiting gas escape from the control duct 200 with the piston 500, the control duct 200 is vented at the drive mechanism. If gas pressure is then applied to the enlarged section 250, a differential pressure between the piston 500 and control unit 400 ensures the piston 500 is driven down the control duct 200 in the first direction D1 shutting the core reaction down.

During normal operation (i.e. an operational configuration) of the nuclear fission reactor system, the control units 400 will be moved along the control duct 200 in the first direction D1 and second direction D2 as required to moderate the reaction in the core 300 as required by use of the drive mechanism 600.

The drive mechanism 600 may move the control units 400 between the operational configuration arrangement as shown in FIGS. 3, 5, which show an arrangement in which the majority of the control units 400 in the first region 310 of the core 300 are displacer units 420, to a shut down configuration arrangement as shown in FIGS. 4, 6, 7 in which the majority of the control units 400 in the first region 310 of the core 300 are absorber units 410. The drive mechanism 600 is operable to locate the control units 400 in positions between those shown in FIGS. 3, 5 and FIGS. 4, 6, 7.

However, as hereinbefore described, the reactor control system 100 is configured so that during a shutdown scenario, the drive mechanism is operable to allow the control units to adopt the arrangement shown in FIGS. 4, 6, 7.

Hence there is provided a control system for a nuclear fission reactor which is more compact than prior designs and overall significantly reduces the size of the reactor unit to which it is included compared to examples of the related art.

Since the reactor control and/or shut down components of the present disclosure extend radially outwards from the reactor core, rather than extending longitudinally from the end of the reactor core, this enables substantial potential for improvements to the overall control system package design.

In some examples, the arrangement of the present disclosure would enable the entire control system to be located within the reactor housing (e.g. the casing 180), and therefore would not increase the overall reactor volume.

Using spherical control units instead of rods has further important safety advantages as rods are prone to warpage due to differential temperatures and neutron irradiation. This has in the past caused shutdown rods to jam preventing automatic shutdown in faulted situations. In contrast, spherical control units are less prone to such jamming due to fundamental segmented nature of the design and only point and line contacts within the control duct 200.

The utilisation of an Archimedes screw, or the like to move the control units allows for accurate drive control of the control units and enables an inherent gearing from a drive motor, reducing the need for control drive motor gearboxes.

The control system 100 may also allow for a horizontally mounted reactor. Horizontal mounting may have advantages in space constrained environments including within submarine hulls. However, if a horizontal arrangement is considered the gravity induced shutdown is no longer practical and a hydraulic or pneumatic insertion of shutdown elements may be required (for example as described in relation to FIG. 10).

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A reactor control system for a nuclear fission reactor system, the nuclear fission reactor system comprising a nuclear reactor unit having a reactor core with a central axis extending along the length of the reactor core, the nuclear reactor unit comprising a first region provided in the reactor core and a second region provided outside of the reactor core, the reactor control system comprising a control duct having:
a first portion configured to extend through the first region; and
a second portion configured to extend through the second region;
the control duct being filled with a series of control units, each of the control units configured to travel along the control duct.

2. The reactor control system of claim 1, wherein:
the control duct is configured for the translation of the control units in a first direction D1 and in a second direction D2;
the first direction D1 being in a direction of travel from the second portion towards the first portion; and
the second direction D2 being in a direction of travel from the first portion towards the second portion.

3. The reactor control of claim 1, wherein the control duct comprises a arcuate portion which extends between the first portion and the second portion, the first portion, arcuate portion and second portion of the control duct thereby defining a continuous path for passage of the control units.

4. The reactor control system of claim 3, wherein the arcuate portion is a first arcuate portion, and the control duct comprises:
a second arcuate portion which extends between the first portion and the second portion;
the second arcuate portion provided at the opposite end of the first portion and second portion to the first arcuate portion, such that the first arcuate portion is spaced apart from the second arcuate portion by the first portion and the second portion; and
the first portion, first arcuate portion, second portion and second arcuate portion of the control duct thereby defining a single continuous loop path for the passage of the control units.

5. The control system of claim 1, further comprising:
a first tank for storage of the control units, the control duct configured to receive and/or supply the control units from/to the first tank; and
a second tank for storage of the control units, the control duct configured to receive and/or supply the control units from/to the second tank;
the first tank, first portion, first arcuate portion, second portion and second tank being provided in series to define a path for the passage of the control units.

6. The reactor control system of claim 1, wherein:
some of the control units are absorber units, and
some of the control units are displacer units.

7. The reactor control system of claim 6, wherein the absorber units are less heavy than the displacer units.

8. The reactor control system of claim 1, wherein the control units are spherical and have an external diameter which is the same as, or slightly smaller than the diameter of the control duct.

9. The reactor control system of claim 1, further comprising: a drive mechanism which in a first mode of operation is operable to drive the control units in a first direction D1 around the control duct, and in a second mode of operation is operable to drive the control units in a second direction D2 around the control duct.

10. The reactor control system of claim 9, wherein the drive mechanism comprises a screw with a track for engagement with the control units, such that when the screw rotates, the control units are driven along the duct.

11. The reactor control system of claim 10, wherein the screw is configured to move between a first position in which it is operable to drive the control units, and a second position in which a clearance is maintained between the screw and the control units.

12. The reactor control system of claim 9, further comprising a non-return mechanism provided in the control duct, the non-return mechanism configured to have a first mode of operation in which the control units are able to move relative to the control duct, and a second mode of operation in which the control units are fixed in position relative to the control duct.

13. The reactor control of claim 1, wherein the control duct has a substantially constant diameter.

14. The reactor control system of claim 11, wherein:
at least part of the second portion of the control duct has a diameter which is greater than a diameter of the first portion of the control duct; and
the second portion of the control duct is in fluid communication with a pressure source, such that when the screw is in the second position, the control units are forced in the first direction D1.

15. The reactor control system claim 1, wherein:
a plurality of absorber units are provided in series and adjacent one another along the control duct to form a line of absorber units;
a first plurality of displacer units are provided in series and adjacent one another along the control duct to form a first line of displacer units; and
a second plurality of displacer units are provided in series and adjacent one another along the control duct to form a second line of displacer units;
the first line of displacer units extend from a first end of the line of absorber units, and the second line of displacer units extending from a second end of the line of absorber units.

16. The reactor control system claim 15, wherein:
the control duct is configured for the translation of the control units in a first direction D1 and in a second direction D2;
the first direction D1 being in a direction of travel from the second portion towards the first portion;
the second direction D2 being in a direction of travel from the first portion towards the second portion; and
a piston is provided between the first line of displacer units and the second line of displacer units, such that in the first direction D1 the plurality of absorber units are spaced apart from the piston by the first line of displacer units, and in the second direction D2 the plurality of absorber units are spaced apart from the piston by the second line of displacer units.

17. The reactor control system 16, comprising:
a drive mechanism which in a first mode of operation is operable to drive the control units in the first direction D1, and in a second mode of operation is operable to drive the control units in a second direction D2, wherein the drive mechanism comprises a screw with a track for engagement with the control units, such that when the screw rotates, the control units are driven along the duct, and wherein the screw is configured to move between a first position in which it is operable to drive the control units, and a second position in which a clearance is maintained between the screw and the control units, and wherein the piston is configured and located in the control duct such that when the screw is in the second position, the piston acts on the control units beneath it to move them around the control duct.

18. The reactor control system of claim 1, wherein:
the first portion of the control duct extends substantially parallel to the core central axis; and
the second portion of the control duct extends substantially parallel to the core-central axis.

19. A nuclear fission reactor system comprising:
a nuclear reactor unit, and
the reactor control system of claim 1.

20. A reactor control system for a nuclear fission reactor system, the nuclear fission reactor system comprising a nuclear reactor unit having a reactor core with a central axis extending along the length of the reactor core, the nuclear reactor unit comprising a first region provided in the reactor core and a second region provided outside of the reactor core, the reactor control system comprising:
a control duct having a first portion configured to extend through the first region, and a second portion configured to extend through the second region;
a plurality of absorber units are provided in series and adjacent one another along the control duct to form a line of absorber units;
a first plurality of displacer units are provided in series and adjacent one another along the control duct to form a first line of displacer units;
a second plurality of displacer units are provided in series and adjacent one another along the control duct to form a second line of displacer units;
the first line of displacer units extend from a first end of the line of absorber units, and the second line of displacer units extending from a second end of the line of absorber units;
a piston between the first line of displacer units and the second line of displacer units, such that in a first direction D1 the plurality of absorber units are spaced apart from the piston by the first line of displacer units, and in a second direction D2 the plurality of absorber units are spaced apart from the piston by the second line of displacer units; and
a drive mechanism which in a first mode of operation is operable to drive the absorber and displacer units in the first direction D1, and in a second mode of operation is operable to drive the absorber and displacer units in a second direction D2.
